(19) United States
(12) Patent Application Publication
(10) Pub. No.: US 2024/0037424 A1
(43) Pub. Date: Feb. 1, 2024

(54) METHODS AND INTERNET OF THINGS (IOT) SYSTEMS FOR MANAGING OPERATION PROGRESSES OF SMART GAS PIPELINE NETWORKS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Bin LIU, Chengdu (CN)

(73) Assignee: CHENGDU QINCHUAN IOT TECHNOLOGY CO., LTD., Chengdu (CN)

(21) Appl. No.: 18/484,424

(22) Filed: Oct. 10, 2023

(30) Foreign Application Priority Data
Sep. 20, 2023 (CN) 202311219615.9

(51) Int. Cl. G06N 5/022

(52) U.S. Cl. CPC G06N 5/022

(57) ABSTRACT

The embodiments of the present disclosure provide methods and Internet of Things (IoT) system for managing an operation progress of a smart gas pipeline network. The method includes: obtaining a construction type and a progress sequence of a gas operation based on a smart terminal and a sensing unit; predicting a future operation progress at a future moment through a progress prediction model based on the construction type and the progress sequence, the progress prediction model being a machine learning model; generating a first prompt message and a second prompt message based on the future operation progress, the first prompt message including the progress reminder data of the gas operation, and the second prompt message including an approach plan of a gas associated object; and sending the first prompt message to a gas operator and sending the second prompt message to the gas associated object.

### CROSS-REFERENCE TO RELATED APPLICATION

This application claims priority to Chinese Patent Application No. 202311219615.9, filed on Sep. 20, 2023, the entire contents of which are hereby incorporated herein by reference.

### TECHNICAL FIELD

The present disclosure relates to the field of computer progress management, and in particular, to methods and Internet of Things (IoT) systems for managing an operation progress of a smart gas pipeline network.

### BACKGROUND

The work (e.g., construction, use, maintenance, renovation, or management) of a gas pipeline network involves a wide range. For example, participation and cooperation of a pipeline network device, a gas service provider, a gas user, a regulatory user, etc. is required and the work is often subject to frequent dynamic changes, which is particularly important in the progress management of an gas operation in the gas pipeline network.

Therefore, it is desirable to provide methods and Internet of Things (IoT) systems for managing an operation progress of a smart gas pipeline network, which may achieve operation progress prediction of the gas operation, update an associated approach plan based on the predicted operation progress, and/or provide a warning to an associated object, so as to improve the overall construction and operation efficiency of the gas pipeline network and enhance user experience.

### SUMMARY

One or more embodiments of the present disclosure provide a method for managing an operation progress of a smart gas pipeline network. The method is implemented based on a smart gas management platform of a smart gas Internet of Things (IoT) system, and the method includes: obtaining a construction type and a progress sequence of a gas operation based on a smart terminal and a sensing unit; predicting a future operation progress at a future moment through a progress prediction model based on the construction type and the progress sequence, the progress prediction model being a machine learning model; generating a first prompt message and a second prompt message based on the future operation progress, the first prompt message including progress reminder data of the gas operation, and the second prompt message including an approach plan of a gas associated object; and sending the first prompt message to a gas operator and sending the second prompt message to the gas associated object.

In some embodiments, the predicting a future operation progress at a future moment through a progress prediction model based on the construction type and the progress sequence includes: determining a target pipeline network structure of the gas operation based on the construction type; generating a pipeline network progress feature map based on the target pipeline network structure and the progress sequence, wherein a node of the pipeline network progress feature map includes a pipeline node and a device node, and a node feature includes at least one of the progress sequence, a completed operation sequence, or a current operation set corresponding to the node; and an edge of the pipeline network progress feature map connects nodes having a preset relationship, and an edge feature includes a relationship feature; and predicting the future operation progress at the future moment through the progress prediction model based on the pipeline network progress feature map, the progress prediction model including at least one convolutional layer and at least one fully connected layer.

In some embodiments, the current operation set includes a current operation and an operation feature corresponding to the current operation; and the operation feature includes a parallel operation set to which the current operation belongs, and the parallel operation set is determined based on a parallel project set.

In some embodiments, the method further includes: obtaining a parallel project set of the gas operation at a current moment, the parallel project set including a parallel operation set, and the parallel operation set including sub-operations performed in parallel; predicting a construction risk based on the construction type, a current operation progress, and the parallel project set at the current moment; adjusting the parallel project set based on the construction risk and generating a third prompt message, the third prompt message including reminder data of an operation risk of the gas operation; and sending the third prompt message to the gas operator.

In some embodiments, the adjusting the parallel project set based on the construction risk includes: in response to the construction risk satisfying a first preset condition, performing a first adjustment on the parallel project set; and in response to an adjusted construction risk satisfying a second preset condition, completing the adjusting. The first adjustment includes determining a target operation from the parallel project set at the current moment and removing the target operation, and the target operation is a sub-operation with a largest associated feature value in a target operation set; a count of the sub-operations performed in parallel in the target operation set is greater than a preset quantity threshold; and an associated feature value of at least one of the sub-operations is an average of correlations between the at least one of the sub-operations and other sub-operations in the target operation set.

In some embodiments, the predicting a construction risk based on the construction type, a current operation progress, and the parallel project set at the current moment includes: determining an operation feature of the at least one of the sub-operations in the parallel project set at the current moment based on the current operation progress; and predicting the construction risk through a risk prediction model based on the construction type, the parallel project set at the current moment, and the operation feature of the at least one of the sub-operations in the parallel project set, the risk prediction model being a machine learning model.

In some embodiments, an input of the risk prediction model further includes future operation progresses of the at least one of the sub-operations at a plurality of future moments; and the future operation progresses are determined based on the progress prediction model, the progress prediction model being the machine learning model.

In some embodiments, the input of the risk prediction model further includes a correlation vector corresponding to the parallel operation set in the parallel project set at the current moment; the correlation vector includes a correlation between the sub-operations in the parallel operation set; and the correlation between the sub-operations is determined by: determining two target nodes corresponding to two of the sub-operations of which the correlation needs to be obtained in the pipeline network progress feature map; obtaining a map distance between the two target nodes in the pipeline network progress feature map; obtaining a similarity between progress sequences of the two target nodes; and determining the correlation between two of the sub-operations based on the map distance and the similarity.

In some embodiments, the risk prediction model includes a first embedding layer, a second embedding layer, and a risk prediction layer; the first embedding layer is configured to determine a first embedding vector based on the parallel project set at the current moment, and the correlation vector corresponding to the parallel operation set in the parallel project set at the current moment, and the operation features of the sub-operations; the second embedding layer is configured to determine a second embedding vector based on the future operation progresses of the sub-operations at the plurality of future moments; and the risk prediction layer is configured to predict the construction risk based on the construction type, the first embedding vector, and the second embedding vector.

One or more embodiments of the present disclosure provide a smart gas Internet of Things (IoT) system comprising a smart gas management platform. The smart gas management platform is configured to obtain a construction type and a progress sequence of a gas operation based on a smart terminal and a sensing unit, predict a future operation progress at a future moment through a progress prediction model based on the construction type and the progress sequence, the progress prediction model being a machine learning model, generate a first prompt message and a second prompt message based on the future operation progress, the first prompt message including progress reminder data of the gas operation, and the second prompt message including an approach plan of a gas associated object, and send the first prompt message to a gas operator and send the second prompt message to the gas associated object.

In some embodiments, the smart gas IoT system further includes a smart gas user platform, a smart gas service platform, a smart gas sensing network platform, and a smart gas object platform, wherein the smart gas user platform includes the smart terminal, and the smart gas object platform includes the sensing unit; and the smart gas user platform and the smart gas object platform are configured to obtain the construction type or the progress sequence of the gas operation; the smart gas service platform is configured to upload the construction type or the progress sequence obtained by the smart gas user platform to the smart gas management platform; and the smart gas sensing network platform is configured to upload the construction type or the progress sequence obtained by the smart gas object platform to the smart gas management platform.

In some embodiments, the smart gas management platform is further configured to determine a target pipeline network structure of the gas operation based on the construction type, generate a pipeline network progress feature map based on the target pipeline network structure and the progress sequence, wherein a node of the pipeline network progress feature map includes a pipeline node and a device node, and a node feature includes at least one of the progress sequence, a completed operation sequence, or a current operation set corresponding to the node; and an edge of the pipeline network progress feature map connects nodes having a preset relationship, and an edge feature includes a relationship feature, and predict the future operation progress at the future moment through the progress prediction model based on the pipeline network progress feature map, the progress prediction model including at least one convolutional layer and at least one fully connected layer.

In some embodiments, the current operation set includes a current operation and an operation feature corresponding to the current operation; and the operation feature includes a parallel operation set to which the current operation belongs, and the parallel operation set is determined based on a parallel project set.

In some embodiments, the smart gas management platform is further configured to obtain a parallel project set of the gas operation at a current moment, the parallel project set including a parallel operation set, and the parallel operation set including sub-operations performed in parallel, predict a construction risk based on the construction type, a current operation progress, and the parallel project set at the current moment, adjust the parallel project set based on the construction risk and generate a third prompt message, the third prompt message including reminder data of an operation risk of the gas operation, and send the third prompt message to the gas operator.

In some embodiments, the smart gas management platform is further configured to in response to the construction risk satisfying a first preset condition, perform a first adjustment on the parallel project set, and in response to an adjusted construction risk satisfying a second preset condition, complete the adjustment. The first adjustment includes determining a target operation from the parallel project at the current moment and removing the target operation, and the target operation is a sub-operation with a largest associated feature value in a target operation set; a count of the sub-operations performed in parallel in the target operation set is greater than a preset quantity threshold; and an associated feature value of at least one of the sub-operations is an average of correlations between the at least one of the sub-operations and other sub-operations in the target operation set.

In some embodiments, the smart gas management platform is further configured to determine an operation feature of the at least one of the sub-operations in the parallel project set at the current moment based on the current operation progress, and predict the construction risk through a risk prediction model based on the construction type, the parallel project set at the current moment, and the operation feature of the at least one of the sub-operations in the parallel project set, the risk prediction model being a machine learning model.

In some embodiments, an input of the risk prediction model further includes future operation progresses of the at least one of the sub-operations at a plurality of future moments; and the future operation progresses are determined based on the progress prediction model, the progress prediction model being the machine learning model.

In some embodiments, the input of the risk prediction model further includes a correlation vector corresponding to the parallel operation set in the parallel project set at the current moment; the correlation vector includes a correlation between the sub-operations in the parallel operation set; and the smart gas management platform is further configured to determine two target nodes corresponding to two of the sub-operations of which the correlation needs to be obtained in the pipeline network progress feature map, obtain a map distance between the two target nodes in the pipeline network progress feature map, obtain a similarity between progress sequences of the two target nodes, and determine the correlation between two of the sub-operations based on the map distance and the similarity.

In some embodiments, the risk prediction model includes a first embedding layer, a second embedding layer, and a risk prediction layer; the first embedding layer is configured to determine a first embedding vector based on the parallel project set at the current moment, and the correlation vector corresponding to the parallel operation set in the parallel project set at the current moment, and the operation features of the sub-operations; the second embedding layer is configured to determine a second embedding vector based on the future operation progress of the sub-operation at a plurality of the future moments; and the risk prediction layer is configured to predict the construction risk based on the construction type, the first embedding vector, and the second embedding vector.

One or more embodiments of the present disclosure provide a non-transitory computer-readable storage medium storing computer instructions. When reading the computer instructions in the storage medium, a computer executes the method for managing an operation progress of a smart gas pipeline network of claim 1.

### BRIEF DESCRIPTION OF THE DRAWINGS

The present disclosure will be further illustrated by way of exemplary embodiments.

These exemplary embodiments will be described in detail by way of drawings. These embodiments are non-limiting exemplary embodiments, in which like reference numerals represent similar structures, wherein:

FIG. 1 is an exemplary schematic diagram illustrating a smart gas Internet of Things (IoT) system according to some embodiments of the present disclosure;

FIG. 2 is an exemplary flowchart illustrating a method for managing an operation progress of a smart gas pipeline network according to some embodiments of the present disclosure;

FIG. 3 is an exemplary schematic diagram illustrating predicting a future operation progress at a future moment according to some embodiments of the present disclosure;

FIG. 4 is an exemplary schematic diagram illustrating a pipeline network progress feature map according to some embodiments of the present disclosure;

FIG. 5 is an exemplary flowchart illustrating generating a third prompt message according to some embodiments of the present disclosure; and

FIG. 6 is an exemplary schematic diagram illustrating a structure of a risk prediction model according to some embodiments of the present disclosure.

### DETAILED DESCRIPTION

In order to more clearly illustrate the technical solutions of the embodiments of the present disclosure, the accompanying figures that are required to be used in the description of the embodiments are briefly described below. Obviously, the accompanying figures in the following description are only some examples or embodiments of the present disclosure, and it is possible for a person of ordinary skill in the art to apply the present disclosure to other similar scenarios in accordance with these figures without creative labor. The present disclosure may be applied to other similar scenarios based on these figures without the expenditure of creative labor. Unless obviously obtained from the context or the context otherwise illustrates, the same numeral in the figures refers to the same structure or operation.

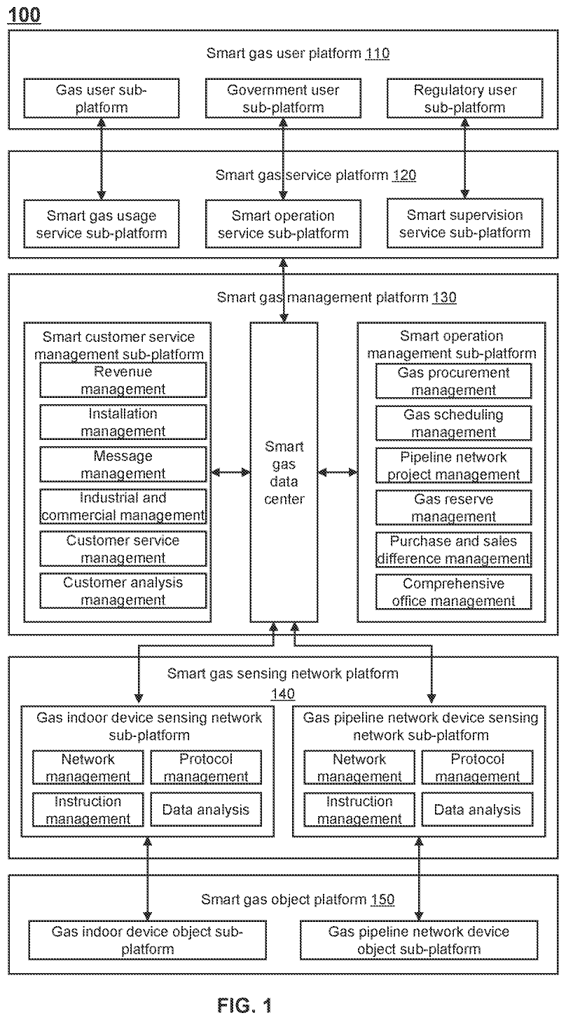

FIG. 1 is an exemplary schematic diagram illustrating a smart gas Internet of Things (IoT) system according to some embodiments of the present disclosure;

In some embodiments, as shown in FIG. 1, the smart gas IoT system 100 may include a smart gas user platform 110, a smart gas service platform 120, a smart gas management platform 130, a smart gas sensing network platform 140, and a smart gas object platform 150 that interact in turn.

The smart gas user platform 110 may be a platform for interacting with a user. In some embodiments, the smart gas user platform 110 may issue an instruction such as pipeline network progress query or pipeline network progress management of a gas operation user and transmit relevant a prompt message (e.g., gas operation progress reminder data, operation risk reminder data, or an approach plan of a gas associated object) to the user (e.g., a gas operator or the gas associated object).

In some embodiments, the smart gas user platform 110 may include a smart terminal (e.g., a terminal device carried by the gas operator, etc.), for example, a smart terminal used to obtain information related to the gas operation (e.g., a construction type or a progress sequence of the gas operation). In some embodiments, the smart gas user platform 110 may also include a gas user sub-platform, a government user sub-platform, and a regulatory user sub-platform.

The smart gas service platform 120 may be a platform for receiving and transmitting data and/or information. In some embodiments, the smart gas service platform 120 may include a smart gas usage service sub-platform, a smart operation service sub-platform, and a smart supervision service sub-platform.

The smart gas management platform 130 may be a platform that coordinates or plans a connection and a collaboration between different functional platforms as a whole, gathers information of the IoT system, and provides functions such as perception management and control management for an operation system of the IoT. In some embodiments, the smart gas management platform 130 may be configured to perform the method for managing an operation progress of a smart gas pipeline network.

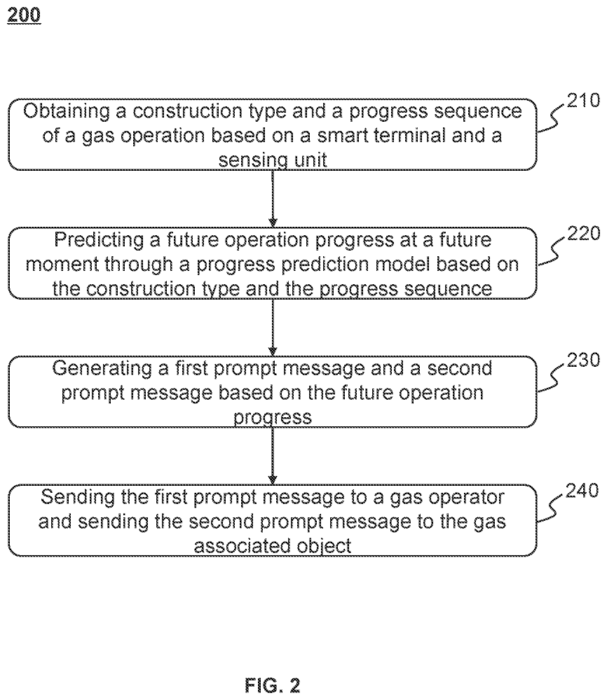

More descriptions regarding the method for managing an operation progress of a smart gas pipeline network may be found elsewhere in the present disclosure, e.g., in FIG. 2 and its related descriptions.

In some embodiments, the smart gas management platform 130 may include a smart customer service management sub-platform, a smart operation management sub-platform, and a smart gas data center.

The smart customer service management sub-platform may be a platform for processing information related to a gas user. In some embodiments, the smart customer service management sub-platform may include, but is not limited to, a module such as revenue management, installation management, message management, industrial and commercial management, customer service management, or customer analysis management. In some embodiments, the message management module may be used to deliver a prompt message related to progress management of the pipeline network to the gas user (e.g., a gas service provider, a gas consumer, and/or a regulatory user).

The smart operation management sub-platform may be a platform for managing gas operation. In some embodiments, the smart operation management sub-platform may include, but is not limited to, a module such as gas procurement management, gas scheduling management, pipeline network project management, gas reserve management, purchase and sales difference management, or comprehensive office management. The comprehensive office management module may be used to coordinate the human resources, public resources, gas devices, daily office, administration, and other affairs.

The smart gas data center may be used to store all operation information of the smart gas IoT system 100. In some embodiments, the smart gas data center may be configured as a storage device for storing data related to the progress management of the pipeline network. For example, the smart gas data center may store related algorithms for predicting a future operation progress and/or related algorithms for predicting a construction risk, and related information of the gas operation uploaded by the smart gas sensing network platform 140.

The smart gas sensing network platform 140 may be a functional platform for managing sensing communication. In some embodiments, the smart gas sensing network platform 140 may achieve functions of perceptual information sensing communication and control information sensing communication. In some embodiments, the smart gas sensing network platform 140 may include a gas indoor device sensing network sub-platform and a gas pipeline network device sensing network sub-platform, which may be used to respectively obtain operation information of a gas indoor device and a gas pipeline network device.

The smart gas object platform 150 may be a functional platform for generating perceptual information and executing control information. In some embodiments, the smart gas object platform 150 may include a sensing unit, such as a gas device at a construction operation site and/or various types of sensors on operation devices. For example, the sensing unit may be used to obtain information related to the gas operation (e.g., the construction type or the progress sequence of the gas operation).

In some embodiments, the smart gas service platform 150 may further include a gas indoor device object sub-platform and a gas pipeline network device object sub-platform. In some embodiments, the gas indoor device object sub-platform may be configured as various types of gas indoor devices (e.g., a metering device) of the gas customer and a gas indoor pipeline. The gas pipeline network device object sub-platform may be configured as various types of gas pipeline devices (e.g., an outdoor gas pipeline, a valve control device, or a pressure regulating device) and a monitoring device (e.g., a temperature sensor or a pressure sensor).

In some embodiments, the smart gas service platform 120 may interact with the smart gas user platform 110 and the smart gas management platform 130. For example, the smart gas service platform 120 may receive a pipeline network progress management instruction issued by the smart gas user platform 110 and transmit the prompt message related to the pipeline network progress management to the smart gas user platform 110. As another example, the smart gas service platform 120 may transmit the pipeline network progress management instruction to the smart gas management platform 130 and receive the prompt message related to the pipeline network progress management issued by the smart gas management platform 130.

In some embodiments, the smart gas sensing network platform 140 may interact with the smart gas management platform 130 and the smart gas object platform 150. For example, the smart gas sensing network platform 140 may send an instruction for obtaining the information related to the gas operation issued by the smart gas management platform 130 to the smart gas object platform 150 and receive the information related to the gas operation (e.g., the construction type or the progress sequence of the gas operation) uploaded by the smart gas object platform 150.

FIG. 2 is an exemplary flowchart illustrating a method for managing an operation progress of a smart gas pipeline network according to some embodiments of the present disclosure. In some embodiments, process 200 may be performed based on a smart gas management platform. As shown in FIG. 2, the process 200 includes the following operations.

In 210, obtaining a construction type and a progress sequence of a gas operation based on a smart terminal and a sensing unit.

The smart terminal refers to one or more terminal devices, such as a mobile phone or a smart bracelet carried by a gas operator. The sensing unit refers to one or more sensing devices deployed at a construction site, such as various types of sensors.

The gas operation refers to a current gas task currently performed, such as construction of a gas pipeline network or maintenance of a gas pipeline network.

The construction type refers to an operation type of the gas operation. In some embodiments, the construction type may include newly building a pipeline network, renovating a pipeline network, repairing a pipeline network, etc.

The progress sequence refers to a sequence composed of the operation progress of the gas operation. In some embodiments, the progress sequence may include the operation progresses of the gas operation at one or more current moments and/or historical moments.

In some embodiments, the smart terminal and the sensing unit may collect the construction type and progress sequence of the gas operation and upload them to the smart gas management platform.

In 220, predicting a future operation progress at a future moment through a progress prediction model based on the construction type and the progress sequence.

The future operation progress refers to progresses of the gas operation at one or more future moments.

In some embodiments, the progress prediction model may be a machine learning model, such as a convolutional neural network model.

An input of the progress prediction model may include the construction type and its corresponding progress sequence. An output of the progress prediction model may include the future operation progress at the future moment.

In some embodiments, the progress prediction model may be obtained by training a plurality of first training samples with first labels. For example, the plurality of first training samples with the first labels may be input into an initial progress prediction model. A loss function is constructed based on the first labels and a predicted result of the initial progress prediction model. The initial progress prediction model is iteratively updated based on the loss function. The training is completed when the loss function of the initial progress prediction model meets a preset condition, wherein the preset condition may be the convergence of the loss function or a count of iterations reaching a threshold, etc.

In some embodiments, the first training sample may include a sample construction type corresponding to a sample operation and a sample progress sequence corresponding to the sample operation in a first historical time period, and the first label may be an operation progress of the sample operation at a second historical time point or a second time period. In some embodiments, the first training sample and the first label may be obtained from historical data. The first historical time period is before the second historical point or the second time period.

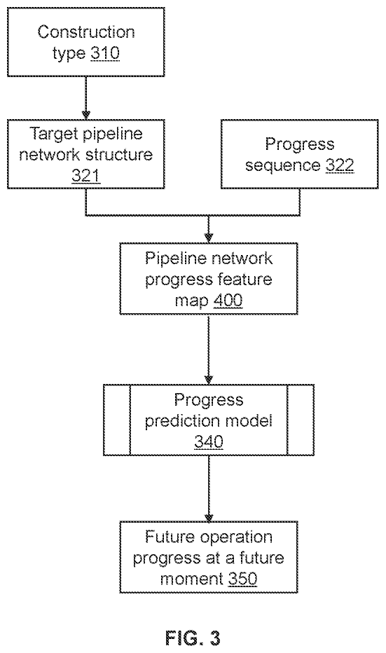

In some embodiments, the input of the progress prediction model may include a pipeline network progress feature map. More descriptions may be found in FIG. 3 and its related descriptions.

In 230, generating a first prompt message and a second prompt message based on the future operation progress.

The first prompt message refers to a prompt message related to the progress of the gas operation. In some embodiments, the first prompt message may include progress reminder data of the gas operation.

The second prompt message refers to a prompt message related to approach of the gas associated object. In some embodiments, the second prompt message may include an approach plan of the gas associated object.

The progress reminder data refers to data related to a gas operation progress reminder, such as data that warns the gas operator to speed up the progress of the gas operation.

The gas associated object refers to an object associated with the gas operation. In some embodiments, the gas associated object may include the gas operator, gas associated personnel (e.g., a gas service provider, a gas user, or a gas regulator), a gas associated device (e.g., a pipeline network device), and a gas management operation (e.g., a temporarily required procurement operation).

The approach plan refers to a plan about a time when the gas associated object participates in the gas operation.

In some embodiments, the smart gas management platform may analyze and process the future operation progress, determine the progress reminder data of the gas operation and the approach plan of the gas associated object, and generate corresponding first prompt message and second prompt message.

In 240, sending the first prompt message to the gas operator and sending the second prompt message to the gas associated object.

In some embodiments, the smart gas management platform may send the first prompt message and the second prompt message in various ways. For example, the smart gas management platform may send the first prompt message and the second prompt message to a smart gas object platform and/or a smart gas user platform based on a smart gas sensing network platform and/or a smart gas service platform via a wired or wireless connection, send the first prompt message to the gas operator, and send the second prompt message to the gas associated object.

In some embodiments of the present disclosure, the future operation progress is predicted based on the construction type and the progress sequence, and the first prompt message and the second prompt message are generated based on the future operation progress, so that the gas operator may be reminded of the progress and, at the same time, the approach plan of the gas associated object may be formulated in advance, which can improve the efficiency of the progress management of the gas pipeline network and help to control the progress of the gas operation as a whole.

FIG. 3 is an exemplary schematic diagram illustrating predicting a future operation progress at a future moment according to some embodiments of the present disclosure.

In some embodiments, the smart gas management platform may determine a target pipeline network structure 321 of a gas operation based on a construction type 310, generate a pipeline network progress feature map 400 based on the target pipeline network structure 321 and a progress sequence 322, and predict the future operation progress at the future moment 350 through the progress prediction model 340 based on the pipeline network progress feature map 400.

The target pipeline network structure 321 refers to a structure of a gas pipeline network when the gas operation is completed.

In some embodiments, the smart gas management platform may determine the target pipeline network structure based on a correspondence between the construction type and the target pipeline network structure.

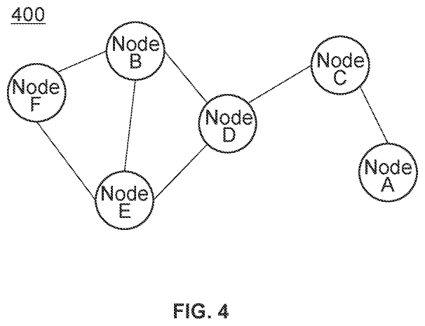

In some embodiments, the smart gas management platform may generate the pipeline network progress feature map 400 based on the target pipeline network structure 321 and the progress sequence 322. More descriptions may be found in FIG. 4 and its related descriptions.

In some embodiments, the progress prediction model 340 may include a machine learning model, such as a Graphic Neural Network (GNN) model. In some embodiments, the progress prediction model 340 may include at least one convolutional layer and at least one fully connected layer. The convolutional layer refers to a network layer structure used to extract a feature in the progress prediction model, and the fully connected layer refers to a network layer structure used for feature integration and classification in the progress prediction model.

In some embodiments, an input of the progress prediction model 340 may include the pipeline network progress feature map 400 and a preset future moment. An output of the progress prediction model 340 may include the operation progress at the preset future moment 350. For example, based on each node of the pipeline network progress feature map 400, the operation progress at the preset future moment 350 corresponding the node may be generated. The preset future moment may be a preset time point in the future.

In some embodiments, the progress prediction model 340 may be obtained by training a second training sample with a second label. The second training sample may include a historical pipeline network progress feature map and a sample future moment determined based on historical data. The second label may be an actual operation progress at a sample future moment actually corresponding to the second training sample. In some embodiments, the second label and the second training sample may be obtained from historical data, and the second label may be manually labeled.

In some embodiments of the present disclosure, the pipeline network progress feature map is introduced into the training of the progress prediction model, so that the gas operation may be modularized by disassembling the gas operation according to a map structure and the predicted operation progress at the future moment may be structural at the same time when a gas scene is combined, which is conducive to considering influence of structural information of objects of different operations on the project progress.

FIG. 4 is an exemplary schematic diagram illustrating a pipeline network progress feature map 400 according to some embodiments of the present disclosure. As shown in FIG. 4, the pipeline network progress feature map 400 may include a node and an edge.

The node refers to a pipeline network device associated with a gas operation. In some embodiments, the node includes a pipeline node (e.g., a gas indoor pipeline or an outdoor pipeline) and a device node (e.g., a valve control device or a pressure regulating device). For example, as shown in FIG. 4, node A, node C, and node D may be indoor gas pipelines and gas devices where gas operations need to be carried out. Node B, node F, and node E may be outdoor gas pipelines and gas devices where gas operations have been completed.

A node feature refers to a feature associated with the gas operation of the corresponding node. In some embodiments, the node feature includes at least one of a progress sequence, a completed operation sequence, or a current operation set corresponding to the node.

In some embodiments, an operation progress may be a metric based on a definition or an input of a user. For example, the operation progress of node A is a ratio of a count of currently completed operations to a total count of operations to be completed. In some embodiments, the historical moment may be a time point based on the input of the user, such as a time point when a phased construction of the gas operation is completed or a time point at a fixed interval since the start of the gas operation.

The completed operation sequence refers to a chronological sequence composed of one or more completed operations. In some embodiments, an operation (also referred to as a gas operation) may include a pipeline operation and a device operation. For example, the pipeline operation may include, but is not limited to, road opening (e.g., road excavation operation before burying a pipeline), preliminary pipeline installation, pipeline connection reinforcement, pipeline gas tightness testing, etc. The device operation may include, but is not limited to, environmental testing, preliminary installation of the gas device, maintenance of the gas device, inspection of the gas device, etc.

The current operation set refers to a set of information about the gas operation that is currently performed. In some embodiments, the current operation set includes the operation currently performed and its operation feature. In some embodiments, the operation feature may include an operation type (e.g., installation, reinforcement, inspection, maintenance, or patrol) of the current operation, a duration that the current operation has performed, etc.

In some embodiments, the operation feature may also include a parallel operation set to which the current operation belongs. The parallel operation set may be determined based on a parallel project set. For example, the smart gas management platform 130 may determine a parallel operation set that associated with the current operation as the parallel operation set to which the current operation belongs to by calling information of the current operation and match the information of the current operation with the current parallel project set.

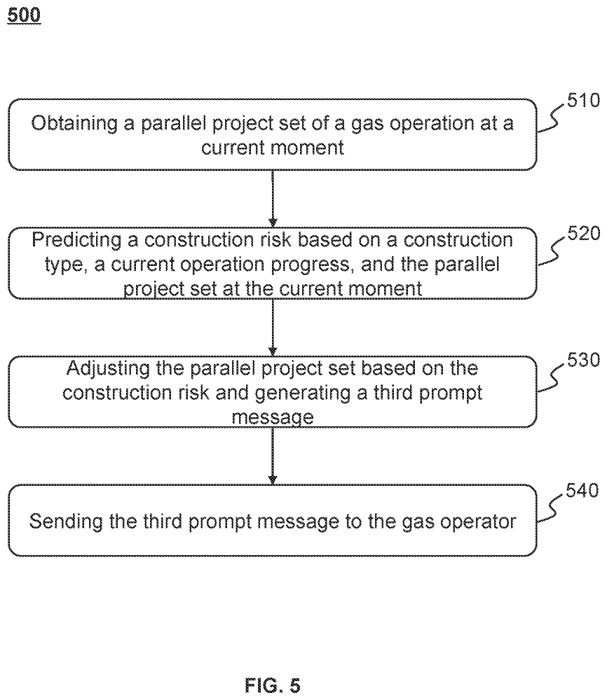

More descriptions regarding the parallel project set, the parallel operation set, and their determination manners may be found elsewhere in the present disclosure, e.g., FIG. 5 and its related descriptions.

In some embodiments of the present disclosure, the pipeline network progress feature map includes the current operation set, specifically the parallel operation set of the current operation, so that the impact of a parallel project on the progress (e.g., the parallel project may accelerate the operation progress) may be taken into account when the future operation progress is predicted based on the pipeline network progress feature map in the progress prediction model, thereby improving the accuracy and effectiveness of the prediction result.

The edge may reflect a connection relationship between nodes related to the gas operation. In some embodiments, the edge of the pipeline network progress feature map connects nodes having a preset relationship. For example, the edge is constructed between nodes having a physical connection.

An edge feature refers to a feature associated with the gas operation and corresponding to the edge. In some embodiments, the edge feature includes a relationship feature. For example, if node A is welded or bolted to node C, the relationship feature of edge A-C is welding or bolting.

In some embodiments, the pipeline network progress feature map and the preset future moment may serve as an input of the progress prediction model, so that the progress prediction model outputs the future operation progress of each node of the pipeline network progress feature map at the preset future moment.

In some embodiments of the present disclosure, the future operation progress at the future moment may be predicted through the progress prediction model based on the pipeline network progress feature map, so that, on one hand, a large-scale gas operation may be disassembled and modularized according to a map structure, thereby making the prediction result more structural and concrete, and on the other hand, the prediction and the prediction result may be closely integrated with a gas scene (e.g., the structure of the gas pipeline network). Additionally, structural information (e.g., features of various nodes and features of various edges) of objects (e.g., nodes and edges) of different gas operations are introduced into the operation progress prediction, which can improve the accuracy and effectiveness of the prediction result.

FIG. 5 is an exemplary flowchart illustrating generating a third prompt message according to some embodiments of the present disclosure. In some embodiments, the process 500 may be performed based on a smart gas management platform. As shown in FIG. 5, the process 500 includes the following operations.

In 510, obtaining a parallel project set of a gas operation at a current moment.

The parallel project set refers to a set of a plurality of gas operation sets that are simultaneously performed. In some embodiments, the parallel project set may include one or more parallel operation sets, and the parallel operation set may include a plurality of sub-operations performed in parallel.

The parallel operation set refers to a set of a plurality of sub-operations that are simultaneously performed, and the sub-operation refers to a gas operation included in the parallel operation set. For example, parallel operation set A includes parallel operation set 1 and parallel operation set 2, wherein parallel operation set 1 specifically includes the sub-operations performed in parallel such as gas operation x11, gas operation x12, . . . , or gas operation x1n.

In some embodiments, the sub-operations in each parallel operation set may be at a same node or at different nodes. For example, the sub-operations performed in parallel at different nodes may include pipeline installation operations that are simultaneously performed at different locations of the gas pipeline network. As another example, the sub-operations performed in parallel at the same node may include a pipeline installation operation and a pipeline reinforcement operation performed simultaneously at a same location of the gas pipeline network.

In some embodiments, different parallel operation sets may be partially or wholly disjoint in terms of an operation time. The sub-operations within a same parallel operation set are performed at a same time.

In some embodiments, the smart gas management platform may obtain the parallel project set of the gas operation at the current moment by querying the gas operation currently performed at the current moment.

In 520, predicting a construction risk based on a construction type, a current operation progress, and the parallel project set at the current moment.

The current operation progress refers to a progress of the gas operation at the current moment.

The construction risk refers to a probability of a potential risk occurring during the gas operation.

In some embodiments, the smart gas management platform may predict the construction risk through table looking up or statistic of historical data based on the construction type, the current operation progress, and the parallel project set at the current moment.

In some embodiments, the smart gas management platform may determine an operation feature of the sub-operation in the parallel project set at the current moment based on the current operation progress, and predict the construction risk through a risk prediction model based on the construction type, the parallel project set at the current moment, and the operation feature of the sub-operation in the parallel project set.

The operation feature of the sub-operation refers to a feature related to the sub-operation, such as a location or an operation difficulty of the sub-operation. In some embodiments, the smart gas management platform may determine the operation feature of the sub-operation at the current moment based on the current operation progress. For example, the smart gas management platform may preset different operation features corresponding to different progresses of various types of gas operations and determine the operation feature of the sub-operation at the current moment based on the current operation progress.

In some embodiments, the risk prediction model may be a machine learning model, such as a neural network (NN) model.

In some embodiments, an input of the risk prediction model may include the construction type, the parallel project set at the current moment, and operation feature of the sub-operation in the parallel project set. An output of the risk prediction model may include the construction risk.

In some embodiments, the risk prediction model may be obtained by training based on a third training sample with a third label. The third training sample may include a sample construction type of a sample operation, a sample parallel project set, and a sample operation feature of a sub-operation in the sample parallel project set obtained based on historical data. The third label may be labeled according to whether a construction accident occurs in the sample operation in the historical data. If the accident occurs in the sample operation, the third label may be 1. If no accident occurs in the sample operation, the third label may be 0. The risk prediction model may be trained in a similar process of training a progress prediction model, which may be found in the related descriptions of the progress prediction model above.

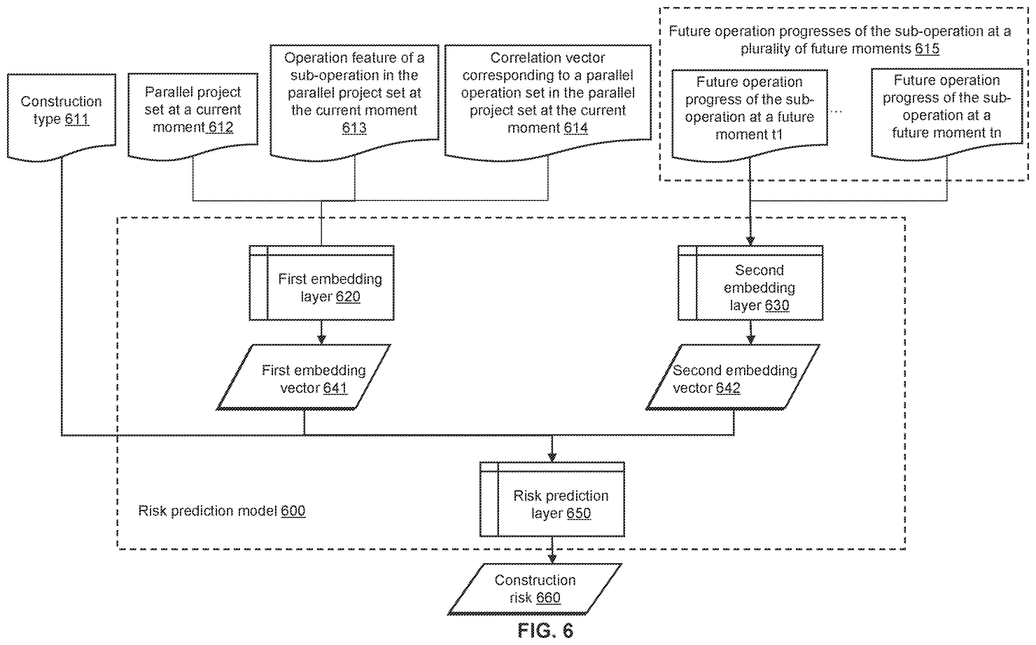

In some embodiments, the input of the risk prediction model may also include future operation progresses of the sub-operation at a plurality of future moments. More descriptions may be found in FIG. 6 and its related descriptions.

In some embodiments of the present disclosure, the construction risk is predicted through the risk prediction model using the self-learning capability of the machine learning model, which may find patterns from a large amount of historical data and help make a more accurate prediction of the construction risk.

In 530, adjusting the parallel project set based on the construction risk and generating a third prompt message.

In some embodiments, the smart gas management platform may adjust the parallel project set in various ways based on the construction risk. For example, when the construction risk is greater than a preset value, the smart gas management platform may reduce a count of parallel sub-operations in the one or more parallel operation sets in the parallel project set, such as delaying the operation time of a particular parallel sub-operation. The preset value may be determined based on historical experience.

In some embodiments, the smart gas management platform may perform a first adjustment on the parallel project set in response to the construction risk satisfying a first preset condition and complete the adjustment in response to an adjusted construction risk satisfying a second preset condition.

The first preset condition is that the construction risk is greater than a first set value. The first set value may be determined based on historical experience.

In some embodiments, the first adjustment may include determining a target operation from the parallel project set at the current moment and removing the target operation.

The target operation refers to a sub-operation with a highest associated feature value in a target operation set.

In some embodiments, the smart gas management platform may determine a parallel operation set with a count of parallel operation items greater than a set value as the target parallel operation set, wherein the count of parallel operation items refers to a count of parallel sub-operations included in a parallel operation set. There may be one or more target parallel operation sets.

An associated feature value of the sub-operation refers to an average of correlations between the sub-operation and other sub-operations in the parallel operation set. In some embodiments, the smart gas management platform may calculate the correlations between each sub-operation and other sub-operations in the target parallel operation set and take the average as the associated feature value of the corresponding sub-operation.

In some embodiments, the smart gas management platform may determine two target nodes corresponding to two sub-operations in the pipeline network progress feature map, calculate a map distance between the two target nodes, and obtain a similarity between progress sequences of the two nodes. A correlation between the two sub-operations may be determined based on the map distance and the similarity. More descriptions may be found in FIG. 6 and its related descriptions.

In some embodiments, the smart gas management platform may calculate the associated feature value of each sub-operation in the target parallel operation set, respectively and select the sub-operation with the largest associated feature value as the target operation.

In some embodiments, the removing the target operation may include delaying the operation time of the target operation.

The second preset condition refers to a condition that the construction risk is smaller than a second set value. The second set value may be determined based on historical experience. The second set value is smaller than or equal the first set value.

In some embodiments of the present disclosure, an error possibility of a sub-operation with a small associated feature value is related to the sub-operation itself, while an error possibility of a sub-operation with a large associated feature value is related to the sub-operation itself and an error of an associated sub-operation. Therefore, the larger the associated feature value of the sub-operation, the greater the probability of error of the sub-operation. The sub-operation with the largest associated feature value may be postponed, which can greatly reduce the construction risk.

The third prompt message refers to a message related to warning a gas operator, such as prompting the gas operator of a possible construction risk during the operation.

In some embodiments, when the construction risk is greater than a preset value, the smart gas management platform may generate a warning message as the third prompt message.

In 540, sending the third prompt message to the gas operator.

In some embodiments, the smart gas management platform may send the third prompt message to a smart gas object platform and/or a smart gas user platform via a wired or wireless connection based on a smart gas sensing network platform and/or a smart gas service platform and send the third prompt message to the gas operator.

In some embodiments of the present disclosure, the parallel project set may be adjusted based on the construction risk, which may increase the count of parallel sub-operations in the parallel project set to improve the operation progress when the progress is slow and reduce the count of parallel sub-operations to reduce the construction risk when the construction risk is relatively large, thereby ensuring a balance between the construction risk and the operation progress during the gas operation.

It should be noted that the descriptions of processes 200 and 500 provided above is for the purpose of example and illustration only, and does not limit the scope of the present disclosure. For those skilled in the art, various modifications and changes may be made to the processes 200 and 500 under the guidance of the present disclosure. However, these modifications and changes are still within the scope of the present disclosure.

FIG. 6 is an exemplary schematic diagram illustrating a structure of a risk prediction model according to some embodiments of the present disclosure.

In some embodiments, the smart gas service platform may predict a construction risk by processing a construction type, a parallel project set at a current moment, and an operation feature of the sub-operation in the parallel project set at the current moment through the risk prediction model. In some embodiments, the risk prediction model is a machine learning model. For example, the risk prediction model includes a neural network (NN) model, a deep neural network (DNN) model, or the like, or any combination thereof.

More descriptions regarding the construction type, the parallel project set at the current moment, the operation feature of the sub-operation in the parallel project set and the determining the construction risk may be found elsewhere in the present disclosure, e.g., FIG. 5 and its related descriptions.

In some embodiments, an input of the risk prediction model also includes future operation progresses of the sub-operation at a plurality of future moments in the parallel project set at the current moment.

In some embodiments, for each sub-operation in a parallel operation set in the parallel project set, its future operation progress at the plurality of future moments may be determined based on the progress prediction model. For example, the progress prediction model may output a future operation progress of each node of the pipeline network progress feature map at a preset future moment using the pipeline network progress feature map and the preset future moment as the input. The future operation progress of each sub-operation may be determined based on the future operation progress of the node at which the corresponding sub-operation is located at the preset future moment. For example, sub-operation 1 in the parallel operation set is located at node E as shown in FIG. 4, and future operation progresses of sub-operation 1 at the plurality of future moments may be determined based on future operation progresses of node E at the corresponding future moments. It should be understood that sub-operation 1 being located at (corresponding to or matching with) node E refers to that an operation object of sub-operation 1 is located at node E.

More descriptions regarding the progress prediction model and the determining the future operation progresses at the future moments may be found elsewhere in the present disclosure, e.g., FIGS. 2, 3, and 4, and their related descriptions.

In some embodiments of the present disclosure, the future operation progresses of the sub-operation at the plurality of future moments may be used as the input of the risk prediction model, so that a prediction result may reflect the impact of the future operation progress of parallel construction tasks on the construction risk, thereby improving the accuracy and effectiveness of the prediction result.

In some embodiments, the input of the risk prediction model also include a correlation vector corresponding to the parallel operation set in the parallel project set at the current moment.

The correlation vector is used to reflect an association relationship between the sub-operations in the parallel operation set. In some embodiments, the correlation vector includes a correlation between the sub-operations in the parallel operation set, for example, the correlation between each two sub-operations of all sub-operations.

In some embodiments, the correlation between the sub-operations may be determined at least based on the pipeline network progress feature map. Specifically, the smart gas management platform may determine the correlation between the sub-operations through the following steps I to IV.

In Step I, the smart gas management platform may determine two target nodes corresponding to two sub-operations of which the correlation needs to be obtained in the pipeline network progress feature map.

For example, sub-operation 1 and sub-operation 2 of which the correlation needs need to be obtained correspond to node A and node B, respectively in the pipeline network progress feature map shown in FIG. 4.

In Step II, the smart gas management platform may obtain a map distance between the two target nodes in the pipeline network progress feature map.

For example, if a shortest path (node A-node C-node D-node B) between node A and node B is used as the map distance, an edge is used as a unit of measurement, a map distance d between node A and node B is 3.

In step III, the smart gas management platform may obtain a similarity between progress sequences of the two target nodes.

In some embodiments, the similarity may reflect an associated feature such as a progress growth rate of the two sub-operations, so that the correlation may effectively reflect the association of the two sub-operations in pipeline network progress management.

For example, the progress sequence of node A is a1, and a1 includes operation progresses x of node A at a plurality of historical moments t. The progress sequence of node B is a2, and a2 includes operation progresses x′ of node B at the plurality of historical moments t. a1 and a2 are aligned in time, and the operation progresses of node A and node B at a same or similar historical moments are compared to obtain the similarity s=s1+s2+ . . . +sn. Where s1 denotes the similarity between the operation progress x1 of node A and the operation progress x1′ of node B under a same historical moment condition, and s2 to sn denote the similarities accordingly.

In some embodiments, the similarity of the operation progresses may be determined based on a proximity of numerical values of the operation progresses. For example, the larger the absolute difference between the numerical values of the operation progresses of two sub-operations, the smaller the similarity. In some embodiments, the similarity may be determined by a corresponding empirical equation, for example, the similarity sn=k/|xn−xn′|, where when the similarity between the progress sequences of node A and node B needs to be obtained, sn denotes the similarity sn of the progress sequences of node A and node B at the historical moment tn, xn denotes the operation progress at the historical moment tn in the progress sequence of node A, xn′ denotes the operation progress at historical moment tn in the progress sequence of node B, and k is a preset coefficient.

In Step IV, the smart gas management platform may determine the correlation between the two sub-operations based on the map distance and the similarity.

For example, the smaller the map distance, the greater the similarity, and the greater the correlation between the two sub-operations. In some embodiments, the correlation may be determined by a corresponding empirical equation, for example, correlation r=αd+βs, where d denotes the map distance, s denotes the similarity, and a and p are preset coefficients.

In some embodiments of the present disclosure, the correlation vector corresponding to the parallel operation set as the input of the risk prediction model, so that the prediction result may reflect the impact of the correlation between parallel construction tasks on the construction risk, thereby making the prediction result more accurate and effective.

In some embodiments, as shown in FIG. 6, the risk prediction model 600 includes a first embedding layer 620, a second embedding layer 630, and a risk prediction layer 650. In some embodiments, the first embedding layer 620, the second embedding layer 630, and/or the risk prediction layer 650 may be selected from any one of the following or their combination: a deep neural network, a recurrent neural network (RNN).

In some embodiments, the first embedding layer 620 may determine a first embedding vector 641 based on the parallel project set at the current moment 612, the operation feature of the sub-operation in the parallel project set at the current moment 613, and the correlation vector corresponding to the parallel operation set in the parallel project set at the current moment 614.

In some embodiments, the second embedding layer 630 may determine a second embedding vector 642 based on the future operation progresses of the sub-operation at the plurality of future moments 615.

In some embodiments, the risk prediction layer 650 may determine the construction risk 660 based on the construction type 611, the first embedding vector 641, and the second embedding vector 642.

In some embodiments, the risk prediction model 600 may be obtained based on a plurality of fourth training samples with fourth labels, and obtained through joint training of the first embedding layer 620, the second embedding layer 630, and the risk prediction layer 650.

In some embodiments, the fourth training sample may include an accident sample where an operation accident occur and a non-accident sample where no operation accident occurs. Both the accident and non-accident samples include a construction type, a parallel project set at the current moment, an operation feature of the sub-operation in the parallel project set at the current moment, and a correlation vector corresponding to the parallel project set and future operation progresses of the sub-operation at the plurality of future moments of a sample operation.

In some embodiments, the training sample may be obtained from historical data, for example, the historical data may be categorized and labeled according to whether a gas operation accident occurs. In some embodiments, the fourth label includes the construction risk, for example, the label of the construction risk of the accident sample is labeled as 1, while the label of the construction risk of the non-accident sample is labeled as 0. In some embodiments, the label of the training sample may be determined through manual or automatic labeling.

In some embodiments, the parallel project set with the plurality of fourth training samples with the fourth labels at the current moment, the operation features of the sub-operations in the parallel project set at the current moment, and the correlation vector corresponding to the parallel project set may be input into an initial first embedding layer. The future operation progresses of the sub-operations of the fourth training samples at the plurality of future moments may be input into an initial second embedding layer. The construction types of the fourth training samples, and the outputs of the initial first embedding layer and the initial second embedding layer may be input into an initial risk prediction layer. A loss function is constructed based on the labels and the outputs of the initial risk prediction layer. Parameters of the initial risk prediction model are iteratively updated based on the loss function through gradient descent or other manners. The model training is completed when a preset condition is met, and a trained risk prediction model is obtained. The preset condition may be that the loss function converges, a count of iterations reaches a threshold, etc.

In some embodiments of the present disclosure, when the construction risk is predicted using the risk prediction model 600, not only a task feature such as the construction type of the gas operation or the parallel project set is considered, but also the correlation vector corresponding to the parallel operation set and/or the future operation progress of the sub-operation is introduced as the input of the model, so that the risk prediction result may take into account the correlation between the parallel gas operation tasks (e.g., the greater the correlation, the higher the possibility of joint operation accident), thereby improving the effectiveness of the prediction results. Additionally, the joint training of the risk prediction model 600 reduces the workload and difficulty of building the model, for example, the labels of the samples are more easily obtained.

One or more embodiments of the present disclosure further provide anon-transitory computer-readable storage medium storing computer instructions. When reading the computer instructions in the storage medium, a computer may execute the method for managing an operation progress of a smart gas pipeline network operation described in any of the above embodiments.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements and amendments to the present disclosure. These alterations, improvements, and modifications are intended to be suggested by this disclosure, and are within the spirit and scope of the exemplary embodiments of this disclosure.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for managing an operation progress of a smart gas pipeline network, wherein the method is implemented based on a smart gas management platform of a smart gas Internet of Things (IoT) system, and the method comprises:
obtaining a construction type and a progress sequence of a gas operation based on a smart terminal and a sensing unit;
predicting a future operation progress at a future moment through a progress prediction model based on the construction type and the progress sequence, the progress prediction model being a machine learning model;
generating a first prompt message and a second prompt message based on the future operation progress, the first prompt message including progress reminder data of the gas operation, and the second prompt message including an approach plan of a gas associated object; and
sending the first prompt message to a gas operator and sending the second prompt message to the gas associated object.

2. The method of claim 1, wherein the predicting a future operation progress at a future moment through a progress prediction model based on the construction type and the progress sequence includes:
determining a target pipeline network structure of the gas operation based on the construction type;
generating a pipeline network progress feature map based on the target pipeline network structure and the progress sequence, wherein
a node of the pipeline network progress feature map includes a pipeline node and a device node, and a node feature includes at least one of the progress sequence, a completed operation sequence, or a current operation set corresponding to the node; and
an edge of the pipeline network progress feature map connects nodes having a preset relationship, and an edge feature includes a relationship feature; and
predicting the future operation progress at the future moment through the progress prediction model based on the pipeline network progress feature map, the progress prediction model including at least one convolutional layer and at least one fully connected layer.

3. The method of claim 2, wherein the current operation set includes a current operation and an operation feature corresponding to the current operation; and
the operation feature includes a parallel operation set to which the current operation belongs, and the parallel operation set is determined based on a parallel project set.

4. The method of claim 1, further comprising:
obtaining a parallel project set of the gas operation at a current moment, the parallel project set including a parallel operation set, and the parallel operation set including sub-operations performed in parallel;
predicting a construction risk based on the construction type, a current operation progress, and the parallel project set at the current moment;
adjusting the parallel project set based on the construction risk and generating a third prompt message, the third prompt message including reminder data of an operation risk of the gas operation; and
sending the third prompt message to the gas operator.

5. The method of claim 4, wherein the adjusting the parallel project set based on the construction risk includes:
in response to the construction risk satisfying a first preset condition, performing a first adjustment on the parallel project set; and
in response to an adjusted construction risk satisfying a second preset condition, completing the adjusting, wherein
the first adjustment includes determining a target operation from the parallel project set at the current moment and removing the target operation, and the target operation is a sub-operation with a largest associated feature value in a target operation set;
a count of the sub-operations performed in parallel in the target operation set is greater than a preset quantity threshold; and
an associated feature value of at least one of the sub-operations is an average of correlations between the at least one of the sub-operations and other sub-operations in the target operation set.

6. The method of claim 4, wherein the predicting a construction risk based on the construction type, a current operation progress, and the parallel project set at the current moment includes:
determining an operation feature of the at least one of the sub-operations in the parallel project set at the current moment based on the current operation progress, and
predicting the construction risk through a risk prediction model based on the construction type, the parallel project set at the current moment, and the operation feature of the at least one of the sub-operations in the parallel project set, the risk prediction model being a machine learning model.

7. The method of claim 6, wherein an input of the risk prediction model further includes future operation progresses of the at least one of the sub-operations at a plurality of future moments; and
the future operation progresses are determined based on the progress prediction model, the progress prediction model being the machine learning model.

8. The method of claim 7, wherein the input of the risk prediction model further includes a correlation vector corresponding to the parallel operation set in the parallel project set at the current moment;
the correlation vector includes a correlation between the sub-operations in the parallel operation set; and
the correlation between the sub-operations is determined by:
determining two target nodes corresponding to two of the sub-operations of which the correlation needs to be obtained in the pipeline network progress feature map;
obtaining a map distance between the two target nodes in the pipeline network progress feature map;
obtaining a similarity between progress sequences of the two target nodes; and
determining the correlation between two of the sub-operations based on the map distance and the similarity.

9. The method of claim 8, wherein the risk prediction model includes a first embedding layer, a second embedding layer, and a risk prediction layer;
the first embedding layer is configured to determine a first embedding vector based on the parallel project set at the current moment, and the correlation vector corresponding to the parallel operation set in the parallel project set at the current moment, and the operation features of the sub-operations;
the second embedding layer is configured to determine a second embedding vector based on the future operation progresses of the sub-operations at the plurality of future moments; and
the risk prediction layer is configured to predict the construction risk based on the construction type, the first embedding vector, and the second embedding vector.

10. A smart gas Internet of Things (IoT) system, comprising a smart gas management platform, wherein the smart gas management platform is configured to:
obtain a construction type and a progress sequence of a gas operation based on a smart terminal and a sensing unit;
predict a future operation progress at a future moment through a progress prediction model based on the construction type and the progress sequence, the progress prediction model being a machine learning model;
generate a first prompt message and a second prompt message based on the future operation progress, the first prompt message including progress reminder data of the gas operation, and the second prompt message including an approach plan of a gas associated object; and
send the first prompt message to a gas operator and send the second prompt message to the gas associated object.

11. The smart gas IoT system of claim 10, further comprising a smart gas user platform, a smart gas service platform, a smart gas sensing network platform, and a smart gas object platform, wherein
the smart gas user platform includes the smart terminal, and the smart gas object platform includes the sensing unit;
the smart gas user platform and the smart gas object platform are configured to obtain the construction type or the progress sequence of the gas operation;
the smart gas service platform is configured to upload the construction type or the progress sequence obtained by the smart gas user platform to the smart gas management platform; and
the smart gas sensing network platform is configured to upload the construction type or the progress sequence obtained by the smart gas object platform to the smart gas management platform.

12. The smart gas IoT system of claim 10, wherein the smart gas management platform is further configured to:
determine a target pipeline network structure of the gas operation based on the construction type;
generate a pipeline network progress feature map based on the target pipeline network structure and the progress sequence, wherein
a node of the pipeline network progress feature map includes a pipeline node and a device node, and a node feature includes at least one of the progress sequence, a completed operation sequence, or a current operation set corresponding to the node; and
an edge of the pipeline network progress feature map connects nodes having a preset relationship, and an edge feature includes a relationship feature; and
predict the future operation progress at the future moment through the progress prediction model based on the pipeline network progress feature map, the progress prediction model including at least one convolutional layer and at least one fully connected layer.

13. The smart gas IoT system of claim 12, wherein the current operation set includes a current operation and an operation feature corresponding to the current operation; and the operation feature includes a parallel operation set to which the current operation belongs, and the parallel operation set is determined based on a parallel project set.

14. The smart gas IoT system of claim 10, wherein the smart gas management platform is further configured to:
obtain a parallel project set of the gas operation at a current moment, the parallel project set including a parallel operation set, and the parallel operation set including sub-operations performed in parallel;
predict a construction risk based on the construction type, a current operation progress, and the parallel project set at the current moment;
adjust the parallel project set based on the construction risk and generate a third prompt message, the third prompt message including reminder data of an operational risk of the gas operation; and
send the third prompt message to the gas operator.

15. The smart gas IoT system of claim 14, wherein the smart gas management platform is further configured to:
in response to the construction risk satisfying a first preset condition, perform a first adjustment on the parallel project set; and
in response to an adjusted construction risk satisfying a second preset condition, complete the adjustment, wherein
the first adjustment includes determining a target operation from the parallel project at the current moment and removing the target operation, and the target operation is a sub-operation with a largest associated feature value in a target operation set;
a count of the sub-operations performed in parallel in the target operation set is greater than a preset quantity threshold; and
an associated feature value of at least one of the sub-operations is an average of correlations between the at least one of the sub-operations and other sub-operations in the target operation set.

16. The smart gas IoT system of claim 14, wherein the smart gas management platform is further configured to:
determine an operation feature of the at least one of the sub-operations in the parallel project set at the current moment based on the current operation progress; and
predict the construction risk through a risk prediction model based on the construction type, the parallel project set at the current moment, and the operational feature of the at least one of the sub-operations in the parallel project set, the risk prediction model being a machine learning model.

17. The smart gas IoT system of claim 16, wherein an input of the risk prediction model further includes future operation progresses of the at least one of the sub-operations at a plurality of future moments; and
the future operation progresses are determined based on the progress prediction model, the progress prediction model being the machine learning model.

18. The smart gas IoT system of claim 17, wherein the input of the risk prediction model further includes a correlation vector corresponding to the parallel operation set in the parallel project set at the current moment;
the correlation vector includes a correlation between the sub-operations in the parallel operation set; and
the smart gas management platform is further configured to:
determine two target nodes corresponding to two of the sub-operations of which the correlation needs to be obtained in the pipeline network progress feature map;
obtain a map distance between the two target nodes in the pipeline network progress feature map;
obtain a similarity between progress sequences of the two target nodes; and
determine the correlation between two of the sub-operations based on the map distance and the similarity.

19. The smart gas IoT system of claim 18, wherein the risk prediction model includes a first embedding layer, a second embedding layer, and a risk prediction layer;
the first embedding layer is configured to determine a first embedding vector based on the parallel project set at the current moment, and the correlation vector corresponding to the parallel operation set in the parallel project set at the current moment, and the operation features of the sub-operations;
the second embedding layer is configured to determine a second embedding vector based on the future operation progress of the sub-operation at a plurality of the future moments; and
the risk prediction layer is configured to predict the construction risk based on the construction type, the first embedding vector, and the second embedding vector.

20. A non-transitory computer-readable storage medium storing computer instructions, wherein when reading the computer instructions in the storage medium, a computer executes the method for managing an operation progress of a smart gas pipeline network of claim 1.
